(19) United States
(12) Patent Application Publication
(10) Pub. No.: US 2025/0333603 A1
(43) Pub. Date: Oct. 30, 2025

(54) Gas Black Derived From Rubber-Derived Pyrolysis Oil

(71) Applicant: Orion Engineered Carbons IP GmbH & Co. KG, Monheim (DE)

(72) Inventors: David Momper, Düsseldorf (DE); Guido Waidmann, Erftstadt (DE); Helmut Franz Gromes, Bergisch Gladbach (DE); Markus Alexander Mahn, Köln (DE); Kai Krauss, Kahl am Main (DE)

(21) Appl. No.: 18/860,735

(22) PCT Filed: Apr. 25, 2023
(86) PCT No.: PCT/EP2023/060747

§ 371 Date: Oct. 28, 2024

(30) Foreign Application Priority Data
Apr. 29, 2022 (EP) 22170980.1

(51) Int. Cl. C09C 1/48; C08K 3/04; C08K 5/17; C09C 1/50; C09D 7/61; C09D 7/63; C09D 11/00; C09D 167/08; C09D 175/06

(52) U.S. Cl. CPC C09C 1/482; C08K 3/04; C08K 5/17; C09C 1/50; C09D 7/20; C09D 7/61; C09D 7/63; C09D 11/00; C09D 167/08; C09D 175/06; C01P 2006/12; C01P 2006/19

(57) ABSTRACT

The present invention relates to a process for producing a carbon black and to carbon black obtained by such process as well as the use of such carbon black. The present invention further relates to compositions including such carbon black and uses of such compositions and articles prepared from such compositions.

### CROSS-REFERENCE TO RELATED APPLICATIONS

This application is the United States national phase of International Patent Application No. PCT/EP2023/060747 filed Apr. 25, 2023, and claims priority to European Patent Application No. 22170980.1 filed Apr. 29, 2022, the disclosures of which are hereby incorporated by reference in their entireties.

### TECHNICAL FIELD

The present invention relates to a process for producing a carbon black and to carbon black obtained by such process as well as the use of such carbon black. The present invention further relates to compositions comprising such carbon black and uses of such compositions and articles prepared from such compositions.

### TECHNICAL BACKGROUND

Carbon black produced by a gas black process provide for beneficial properties in many applications, e.g., as pigments.

However, gas blacks are conventionally produced using fossil raw materials, such as coal and crude oil. Fossil raw materials are limited and they are depleting at a fast rate. Moreover, fossil raw materials mainly have a negative impact on the environment, as their extraction and transport can have a high environmental impact. For example, oil spills have occurred in the past leading to pollution of water bodies and death of aquatic animals including those living offshore. In addition, the combustion of fossil raw materials and thus production of carbon dioxide is known to be one of the primary factors responsible for global warming. Unstable prices and dependence on politically unstable regions for the transport of fossil raw materials are further reasons for the pursuit of alternatives to fossil raw materials.

It is desirable to avoid the disadvantages derived from the use of fossil raw materials. Recyclable materials used as feedstock for the production of carbon blacks is more environmentally friendly. The use of recyclable feedstock contributes to the preservation of limited fossil resources and it creates opportunities for the realization of a circular economy. However, replacing fossil feedstocks with other feedstocks in the gas black process is difficult because the gas black reactor is prone to clogging of the feed lines and burners, requiring shutdown and disassembly of the apparatus for cleaning.

Depending on the various applications, it is desirable that carbon black materials produced from recyclable feedstocks exhibit certain properties comparable to known carbon blacks.

It is therefore an objective of the present invention to provide a process for the production of carbon blacks, which creates opportunities for the realization of a circular economy and provides carbon blacks having comparable properties to known and established carbon blacks.

### SUMMARY OF THE INVENTION

It has surprisingly been shown, that the objective can be solved by the process and the carbon black obtained by the process as disclosed in the independent claims. Specific or preferred variants of the present invention are set forth in the dependent claims.

The following clauses summarize some aspects of the present invention.

A first aspect of the present invention relates to a process for producing carbon black through thermal oxidative decomposition of a carbon black feedstock, wherein the carbon black feedstock comprises rubber-derived pyrolysis oil, and wherein the production of the carbon black is carried out in a gas black reactor.

A second aspect of the present invention relates to the process according to the first aspect, wherein the rubber-derived pyrolysis oil comprises tire-derived pyrolysis oil (TPO).

A third aspect of the present invention relates to the process according to the first aspect or second aspect, wherein the rubber-derived pyrolysis oil consists of tire-derived pyrolysis oil (TPO).

A fourth aspect of the present invention relates to the process according to any one of the preceding aspects, wherein the rubber-derived pyrolysis oil has:
a total carbon in a range of from 80.0 to 90.0 mass %;
a total hydrogen in a range of 8.0 to 15.0 mass %; and
a C/H atomic ratio in a range of from 0.60 to 1.0;
   wherein the mass % is based on the total mass of the rubber-derived pyrolysis oil excluding water and ash content and wherein the total carbon and the total hydrogen are determined according to ASTM D5291C-21.

A fifth aspect of the present invention relates to the process according to any one of the preceding aspects, wherein the rubber-derived pyrolysis oil has:
a total carbon in a range of from 85.0 to 90.0 mass %;
a total hydrogen in a range of 8.0 to 11.0 mass %; and
a C/H atomic ratio in a range of from 0.65 to 1.0;
   wherein the mass % is based on the total mass of the rubber-derived pyrolysis oil excluding water and ash content and wherein the total carbon and the total hydrogen are determined according to ASTM D5291C-21.

A sixth aspect of the present invention relates to the process according to any one the of the preceding aspects, wherein the rubber-derived pyrolysis oil has:
a total carbon in a range of from 86.0 to 90.0 mass %;
a total hydrogen in a range of 8.5 to 10.5 mass %; and
a C/H atomic ratio in a range of from 0.70 to 0.90;
   wherein the mass % is based on the total mass of the rubber-derived pyrolysis oil excluding water and ash content and wherein the total carbon and the total hydrogen are determined according to ASTM D5291C-21.

A seventh aspect of the present invention relates to the process according to any one of the preceding aspects, wherein the rubber-derived pyrolysis oil has:
a total carbon in a range of from 87.0 to 90.0 mass %;
a total hydrogen in a range of 9.0 to 10.0 mass %; and
a C/H atomic ratio in a range of from 0.70 to 0.85;
   wherein the mass % is based on the total mass of the rubber-derived pyrolysis oil excluding water and ash content and wherein the total carbon and the total hydrogen are determined according to ASTM D5291C-21.

An eighth aspect of the present invention relates to the process according to any one of the preceding aspects, wherein the rubber-derived pyrolysis oil has:
a total nitrogen of up to 1.00 mass %; and/or
a total sulfur of up to 1.35 mass %;
   wherein the mass % is based on the total mass of the rubber-derived pyrolysis oil excluding water and ash content and wherein the total nitrogen and the total sulfur are determined according to ASTM D5291C-21.

A ninth aspect of the present invention relates to the process according to any one of the preceding aspects, wherein the rubber-derived pyrolysis oil has:
a total nitrogen of up to 0.80 mass %; and/or
a total sulfur of up to 1.25 mass %;
   wherein the mass % is based on the total mass of the rubber-derived pyrolysis oil excluding water and ash content and wherein the total nitrogen and the total sulfur are determined according to ASTM D5291C-21.

A tenth aspect of the present invention relates to the process according to any one of the preceding aspects, wherein the rubber-derived pyrolysis oil has:
a total nitrogen of up to 0.65 mass %; and/or
a total sulfur of up to 1.20 mass %;
   wherein the mass % is based on the total mass of the rubber-derived pyrolysis oil excluding water and ash content and wherein the total nitrogen and the total sulfur are determined according to ASTM D5291C-21.

An eleventh aspect of the present invention relates to the process according to one any of the preceding aspects, wherein the rubber-derived pyrolysis oil has:
an ash content of less than 0.04 mass %, wherein the mass % is based on the total mass of the rubber-derived pyrolysis oil and wherein the ash content is determined according to ASTM D2415-20.

A twelfth aspect of the present invention relates to the process according to any one of the preceding aspects, wherein the rubber-derived pyrolysis oil has:
an ash content of less than 0.03 mass %, wherein the mass % is based on the total mass of the rubber-derived pyrolysis oil and wherein the ash content is determined according to ASTM D2415-20.

A thirteenth aspect of the present invention relates to the process according to any one of the preceding aspects, wherein the rubber-derived pyrolysis oil has:
a sieve residue of up to 250 mg/kg, based on the total weight of the rubber-derived pyrolysis oil and determined according to ASTM D4870-18 (25 μm mesh size).

A fourteenth aspect of the present invention relates to the process according to any one of the preceding aspects, wherein the rubber-derived pyrolysis oil has:
a sieve residue of up to 230 mg/kg, based on the total weight of the rubber-derived pyrolysis oil and determined according to ASTM D4870-18 (25 μm mesh size).

A fifteenth aspect of the present invention relates to the process according to any one the second to fourteenth aspects, wherein the tire-derived pyrolysis oil (TPO) has:
a total carbon in a range of from 85.0 to 90.0 mass %;
a total hydrogen in a range of 8.0 to 11.0 mass %; and
a C/H atomic ratio in a range of from 0.65 to 1.0;
   wherein the mass % is based on the total mass of the TPO excluding water and ash content and wherein the total carbon and the total hydrogen are determined according to ASTM D5291C-21.

A sixteenth aspect of the present invention relates to the process according to any one of the second to fifteenth aspects, wherein the TPO has:
a total carbon in a range of from 86.0 to 90.0 mass %;
a total hydrogen in a range of 8.5 to 10.5 mass %; and
a C/H atomic ratio in a range of from 0.70 to 0.90;
   wherein the mass % is based on the total mass of the TPO excluding water and ash content and wherein the total carbon and the total hydrogen are determined according to ASTM D5291C-21.

A seventeenth aspect of the present invention relates to the process according to any one of the second to sixteenth aspects, wherein the TPO has:
a total carbon in a range of from 87.0 to 90.0 mass %;
a total hydrogen in a range of 9.0 to 10.0 mass %; and
a C/H atomic ratio in a range of from 0.70 to 0.85;
   wherein the mass % is based on the total mass of the TPO excluding water and ash content and wherein the total carbon and the total hydrogen are determined according to ASTM D5291C-21.

An eighteenth aspect of the present invention relates to the process according to any one of the second to seventeenth aspects, wherein the TPO has:
a total nitrogen of from 0.40 to 0.65 mass %; and/or
a total sulfur of up to 1.35 mass %;
   wherein the mass % is based on the total mass of the TPO excluding water and ash content and wherein the total nitrogen and the total sulfur are determined according to ASTM D5291C-21.

A nineteenth aspect of the present invention relates to the process according to any one of the second to eighteenth aspects, wherein the TPO has:
a total nitrogen of from 0.45 to 0.65 mass %; and/or
a total sulfur of up to 1.25 mass %;
   wherein the mass % is based on the total mass of the TPO excluding water and ash content and wherein the total nitrogen and the total sulfur are determined according to ASTM D5291C-21.

A twentieth aspect of the present invention relates to the process according to any one of the second to nineteenth aspects, wherein the TPO has:
a total nitrogen of from 0.45 to 0.60 mass %; and/or
a total sulfur of up to 1.20 mass %;
   wherein the mass % is based on the total mass of the TPO excluding water and ash content and wherein the total nitrogen and the total sulfur are determined according to ASTM D5291C-21.

A twenty-first aspect of the present invention relates to the process according to one of the second to twentieth aspects, wherein the TPO has:
an ash content of less than 0.04 mass %, wherein the mass % is based on the total mass of the TPO and wherein the ash content is determined according to ASTM D2415-20.

A twenty-second aspect of the present invention relates to the process according to one of the second to twenty-first aspects, wherein the TPO has:
an ash content of less than 0.03 mass %, wherein the mass % is based on the total mass of the TPO and wherein the ash content is determined according to ASTM D2415-20.

A twenty-third aspect of the present invention relates to the process according to any one of the second to twenty-second aspects, wherein the TPO has:
a sieve residue of up to 250 mg/kg, based on the total weight of the TPO and determined according to ASTM D4870-18 (25 μm mesh size).

A twenty-fourth aspect of the present invention relates to the process according to any one of the second to twenty-third aspects, wherein the TPO has:
a sieve residue of up to 230 mg/kg, based on the total weight of the TPO and determined according to ASTM D4870-18 (25 μm mesh size).

A twenty-fifth aspect of the present invention relates to the process according to any one of the preceding aspects, wherein the carbon black feedstock further comprises conventional carbon black feedstock including coal tar distillates, residual oils produced during the catalytic cracking of petroleum fractions, residual oils produced during olefin production through cracking of naphta or gas oil, or mixture of combinations of any of the foregoing, preferably coal tar distillates.

A twenty-sixth aspect of the present invention relates to the process according to any one of the preceding aspects, wherein the carbon black feedstock comprises at least 10 wt.-%, preferably at least 30 wt.-%, more preferably at least 50 wt.-%, even more preferably at least 70 wt.-%, most preferably at least 90 wt.-% of the rubber-derived pyrolysis oil, based on the total weight of the carbon black feedstock.

A twenty-seventh aspect of the present invention relates to the process according to any one of the preceding aspects, wherein the carbon black feedstock consists of the rubber-derived pyrolysis oil.

A twenty-eighth aspect of the present invention relates to the process according to any one of the preceding aspects, wherein the rubber-derived pyrolysis oil comprises at least 10 wt.-%, preferably at least 30 wt.-%, more preferably at least 50 wt.-%, even more preferably at least 70 wt.-%, most preferably at least 90 wt.-% of the tire-derived pyrolysis oil (TPO), based on the total weight of the rubber-derived pyrolysis oil.

A twenty-ninth aspect of the present invention relates to the process according to any one of the preceding aspects comprising vaporizing the carbon black feedstock in a carrier gas stream, burning the carrier gas stream loaded with the carbon black feedstock in the presence of air in burners to form the carbon black, and terminating the carbon black formation.

A thirtieth aspect of the present invention relates to a carbon black obtained by the process according to any one of the preceding claims, wherein the carbon black is a gas black.

A thirty-first aspect of the present invention relates to the carbon black according to the thirtieth aspect, wherein the carbon black has:
an oil absorption number (OAN) of equal to or more than 110 mL/100 g, wherein the OAN is determined according to ASTM D2414-21.

A thirty-second aspect of the present invention relates to the carbon black according to the thirtieth aspect or the thirty-first aspect, wherein the carbon black has:
a volatile matter content of equal to or more than 6%, wherein the volatile matter content (at 950° C.) is determined according to DIN 53552:1977-09.

A thirty-third aspect of the present invention relates to the carbon black according to any one of the thirtieth to the thirty-second aspects, wherein the carbon black has an OAN in a range of from 110 to 180 mL/100 g, preferably 115 to 165 mL/100 g; wherein the OAN is determined according to ASTM D2414-21.

A thirty-fourth aspect of the present invention relates to the carbon black according to any of the thirtieth to the thirty-third aspects, wherein the carbon black has a volatile matter content in a range of from 6% to 10%; wherein the volatile matter content (at 950° C.) is determined according to DIN 53552:1977-09.

A thirty-fifth aspect of the present invention relates to the carbon black according to any one of the thirtieth to the thirty-fourth aspects, wherein the carbon black has a STSA in a range of from 70 to 300 m²/g, preferably from 70 to 270 m²/g, more preferably 80 to 250 m²/g; wherein the STSA is determined according to ASTM D6556-19a.

A thirty-sixth aspect of the present invention relates to the carbon black according to any of the thirtieth to the thirty-fifth aspects, wherein the carbon black has a BET surface area in a range of from 80 to 350 m²/g, preferably from 80 to 320 m²/g, further preferably from 90 to 300 m²/g; wherein the BET surface area is determined according to ASTM D6556-19a.

A thirty-seventh aspect of the present invention relates to the carbon black according to any one of the thirtieth to the thirty-sixth aspects, wherein the carbon black has a tint strength in a range of from 30 to 250%, preferably from 50 to 160%; wherein the tint strength is determined according to ASTM D3265-21.

A thirty-eighth aspect of the present invention relates to the carbon black according to any one of the thirtieth to the thirty-seventh aspects, wherein the carbon black has a pMC (percent of modern carbon) in a range of from 1 to 65%, preferably from 5 to 60%, more preferably from 10 to 60%, even more preferably from 15 to 55%, wherein the pMC is determined according to ASTM D6866-20 Methode B (AMS).

A thirty-ninth aspect of the present invention relates to the carbon black according to the thirtieth to the thirty-eighth aspects, wherein the carbon black is oxidized and/or functionalized.

A fortieth aspect of the present invention relates to use of the carbon black according to the thirtieth to the thirty-ninth aspects as reinforcing filler or additives, UV stabilizer, conductive carbon black or pigment, preferably pigment.

A forty-first aspect of the present invention relates to use of the carbon black according to the thirtieth to the thirty-ninth aspects in rubber and rubber mixtures, plastics, inks such as printing inks, inkjet inks or other inks, toners, lacquers, coatings, papers, adhesives, in batteries or black matrix applications, preferably inks, lacquers and coatings.

A forty-second aspect of the present invention relates to a composition comprising the carbon black according to the thirtieth to the thirty-ninth aspects.

A forty-third aspect of the present invention relates to the composition according to the forty-second aspect, wherein the composition is an ink composition, a coating composition or a lacquer composition.

A forty-fourth aspect of the present invention relates to an article prepared from the composition according to the forty-third aspect.

A forty-fifth aspect of the present invention relates to the article according to the forty-fourth aspect being a coating or a colored or printed article.

### DESCRIPTION OF THE INVENTION

The present invention relates to a process for producing carbon black through thermal oxidative decomposition of a carbon black feedstock. The carbon black feedstock of the present invention comprises rubber-derived pyrolysis oil. The production of the carbon black is carried out in a gas black reactor. Accordingly, the process of the present invention is a gas black process.

As used herein, the term “carbon black” relates to a material composed substantially, e.g., to more than 80 wt. %, or more than 90 wt. % or more than 95 wt. %, based on its total weight of carbon. The production of carbon blacks by the gas black process is well known in the art and for example outlined in J.-B. Donnet et al., “Carbon Black: Science and Technology”, 2^{nd} edition, Marcel Dekker, Inc, New York (1993) on pages 57 and 58; in H. Ferch “Pigmentruße”, 1^{st} edition, Curt R. Vincentz Verlag, Hannover (1995) on pages 31 to 33; and in “Ullmann's Encyclopedia of Chemical Engineering”, 3^{rd} edition, Volume 14 (1963) on page 798 and 799, as well as in DE 845 683 C, DE 504 428 C and U.S. Pat. No. 3,978,019.

A conventional gas black reactor is as displayed in H. Ferch “Pigmentruße”, 1^{st} edition, Curt R. Vincentz Verlag, Hannover (1995) on page 33 as well as in “Ullmann's Encyclopedia of Chemical Engineering”, 3^{rd} edition, Volume 14 (1963) on page 799.

The process of the present invention may comprise vaporizing the carbon black feedstock in a carrier gas stream, burning the carrier gas stream loaded with the carbon black feedstock in the presence of air in burners to form the carbon black, and terminating the carbon black formation.

The carbon black feedstock of the present invention may be heated in a vaporizer and the resultant vapors are carried out by the carrier gas to the burners. The carrier gas stream may comprise hydrogen, oxygen, nitrogen, methane, natural gas, CO₂, and mixtures thereof. The carrier gas may be loaded with the vaporized carbon black feedstock to contain 400 to 2200 g of the vaporized carbon black feedstock per m³ of the carrier gas. The carrier gas may be passed, e.g., in direct or counter-flow over the carbon black feedstock or the carrier gas may be led over the carbon black at rest. Preferably, the carrier gas is heated to suitable temperatures, e.g., to the vaporizing temperatures of the carbon black feedstock, such as to temperatures in the range of from 200 to 400° C. Upon delivery of the mixture comprising the carrier gas and the vaporized carbon black feedstock to the burners, the temperature of the mixture of the carrier gas and the vaporized carbon black feedstock may be within such a range that there is no deposition of the carbon black feedstock in the pipes or burners or premature decomposition. Preferably, the temperature up to the burners is maintained so that it does not exceed 350 to 400° C.

The carrier gas loaded with the vaporized carbon black feedstock may be burned in the presence of air in burners to form the carbon black. The carbon black formation typically is terminated by deposition of the formed carbon black on a cooled device, e.g., cylinders, movable sledge-like conduits, dish apparatus, or the like. The deposition device may be cooled with water.

In conventional gas black reactors, a gas black burner and a deposition device, such a deposition roller are generally disposed jointly in a housing. A water-cooled deposition roller may have a diameter of from 0.4 to 0.7 m and a length of from 3 to 7 m, and it typically rotates at 0.8 to 1.25 rpm. At the upper part of the housing, the exhaust gas may be sucked off and guided by way of pipe lines to the filter plant. The carrier gas generally enters through the open underside of the housing. In the conventional gas black reactor, individual cast iron burners may be disposed side by side, which produces a fan-shaped diffusion flame by means of a flat nozzle disposed perpendicularly to the axis of the deposition roller. The burners are typically positioned onto connections located in the jacket of a gas supply pipe. The gas supply pipe may be disposed below the cooling roller in parallel to its axis. The distance of the burner nozzles may be selected such that the flames burn against the rotating roller and are chilled thereby.

As used herein, the term “rubber-derived pyrolysis oil” relates to the liquid fraction obtained in the pyrolysis of rubber articles. The rubber-derived pyrolysis oil typically contains a mixture of saturated and unsaturated hydrocarbons and may contain polar compounds including sulfur, nitrogen and oxygen.

The pyrolysis of rubber articles generally involves heating the rubber articles to temperatures, e.g., of at least 300° C. in the absence of oxygen in order to volatilize and decompose the rubber articles, producing oil, gas, and char. As used herein, the term “rubber articles” refers to articles composed of rubber, e.g., composed of at least 50 wt.-% of rubber, based on the total weight of the rubber article. Examples of rubber articles include, but are not limited to, tires, conveyer belts, gaskets, such as door gaskets, drive belts, floor mats, shoe soles, belts, cable sheaths, hoses, and the like. Preferred rubber articles include tires. The term “rubber” includes both natural and synthetic rubbers or mixtures thereof. Natural rubber may be obtained from rubber trees (Helvea brasiliensis), guayule, and dandelion. Synthetic rubber may comprise styrene-butadiene rubber such as emulsion-styrene-butadiene rubber and solution-styrene-butadiene rubber, polybutadiene, polyisoprene, ethylene-propylene-diene rubber, ethylene-propylene rubber, butyl rubber, halogenated butyl rubber, chlorinated polyethylene, chlorosulfonated polyethylene, acrylonitrile-butadiene rubber, hydrogenated acrylonitrile-butadiene rubber, polychloroprene, acrylate rubber, ethylene-vinylacetate rubber, ethylene-acrylic rubber, epichlorohydrin rubber, silicone rubber, fluorosilicone rubber, fluorocarbon rubber or mixture of combinations of any of the foregoing.

According to the present invention, the rubber-derived pyrolysis oil may comprise tire-derived pyrolysis oil (TPO). As used herein, the term “tire-derived pyrolysis oil” (“TPO”) relates to the liquid fraction obtained in the pyrolysis of tires in the absence of oxygen. The TPO generally contains a mixture of saturated and unsaturated hydrocarbons and may contain polar compounds including sulfur, nitrogen and oxygen. Typically, waste tires, which are also known as “end-of-life” tires (ELT) are used in the pyrolysis to obtain TPO. As used herein, “waste tires” or “end-of-life tires” refer to tires, such as truck tires, passenger tires, off-road tires, aircraft tires, agricultural tires, and earth-mover tires, which are not suitable for use on vehicles due to, e.g., wear or irreparable damage such as punctures.

The process of pyrolysis of rubber articles, such as tires is well known in the art and involves heating the tires in the absence of oxygen. Suitable processes for obtaining rubber-derived pyrolysis oil, and in particular TPO, include, but are not limited to those which are described in US 2002/0072641 A1, US 2002/0072640 A1, US2005/0101812 A1 and EP 2 427 533 A1.

The rubber-derived pyrolysis oil may comprise at least 5 wt.-%, such as at least 10 wt.-%, or at least 10 wt.-%, or at least 15 wt.-%, or at least 20 wt.-%, or at least 25 wt.-%, or at least 30 wt.-%, or at least 35 wt.-%, or at least 40 wt.-%, or at least 45 wt.-%, or at least 50 wt.-%, or at least 55 wt.-%, or at least 60 wt.-%, or at least 65 wt.-%, or at least 70 wt.-%, or at least 75 wt.-%, or at least 80 wt.-%, or at least 85 wt.-%, or at least 90 wt.-%, or at least 95 wt.-%, or at least 99 wt.-% of tire-derived pyrolysis oil (TPO), based on the total weight of the rubber-derived pyrolysis oil. According to the present invention, the rubber-derived pyrolysis oil may comprise at least 10 wt.-%, preferably at least 30 wt.-%, more preferably at least 50 wt.-%, even more preferably at least 70 wt.-%, most preferably at least 90 wt.-% of TPO, based on the total weight of the rubber-derived pyrolysis oil. The rubber-derived pyrolysis oil of the present invention may consist of TPO.

Suitable examples of rubber-derived pyrolysis oil, and in particular TPO, include, but are not limited to, ThermoTireOil RR, commercially available from Pyrum Innovations AG (Germany).

According to the invention, the rubber-derived pyrolysis oil may have a flash point of at least 3° C., preferably at least 5° C., more preferably 50° C., most preferably at least 65° C. As used herein, the term “flash point” relates to the lowest temperature at which a volatile material vaporizes to form an ignitable mixture in air. The flash point may be determined according to ASTM D93 D. The rubber-derived pyrolysis oil may be treated by distillation, such as fractional distillation at atmospheric pressure, thin film distillation, or the like, to obtain fractions having a higher flash point of, e.g., of at least 65° C.

According to the present invention, the rubber-derived pyrolysis oil may have a total carbon of at least 80.0 mass %, such as at least 81.0 mass %, or at least 82.0 mass %, or at least 83.0 mass %, or at least 84.0 mass %, or at least 85.0 mass %, or at least 85.5 mass %, or at least 86.0 mass %, or at least 86.5 mass %, or at least 87.0 mass %, or at least 87.5 mass %, wherein the mass % is based on the total mass of the rubber-derived pyrolysis oil excluding water and ash content. The rubber-derived pyrolysis oil may have a total carbon of 90.0 mass % or less, such as 89.5 mass % or less, or 89.0 mass % or less, wherein the mass % is based on the total mass of the rubber-derived pyrolysis oil excluding water and ash content. The water content may be determined according to ASTM D4928-12R18 and the ash content may be determined according to ASTM D2415-20 (at 550° C.). A person skilled in the art will appreciate that any range between any of the explicitly disclosed lower and upper limit is herein disclosed. Accordingly, the rubber-derived pyrolysis oil may have a total carbon in a range of from 80.0 to 90.0 mass %, preferably from 85.0 to 90.0 mass %, more preferably from 86.0 to 90.0 mass %, most preferably from 87.0 to 90.0 mass %, wherein the mass % is based on the total mass of the rubber-derived pyrolysis oil excluding water and ash content. The total carbon is determined according to ASTM D5291C-21.

According to the present invention, the rubber-derived pyrolysis oil may have a total hydrogen of at least 8.0 mass %, such as at least 8.5 mass %, or at least 9.0 mass %, or at least 9.5 mass %, wherein the mass % is based on the total mass of the rubber-derived pyrolysis oil excluding water and ash content. The water content may be determined according to ASTM D4928-12R18 and the ash content may be determined according to ASTM D2415-20 (at 550° C.). The rubber-derived pyrolysis oil may have a total hydrogen of 15.0 mass % or less, such as 14.0 mass % or less, or 13.0 mass % or less, or 12.0 mass % or less, or 11.0 mass % or less, or 10.5 mass % or less, or 10.0 mass % or less, wherein the mass % is based on the total mass of the rubber-derived pyrolysis oil excluding water and ash content. A person skilled in the art will appreciate that any range between any of the explicitly disclosed lower and upper limit is herein disclosed. Accordingly, the rubber-derived pyrolysis oil may have a total hydrogen in a range of from 8.0 to 15.0 mass %, preferably from 8.0 to 11.0 mass %, more preferably from 8.5 to 10.5 mass %, most preferably from 9.0 to 10.0 mass %, wherein the mass % is based on the total mass of the rubber-derived pyrolysis oil excluding water and ash content. The total hydrogen is determined according to ASTM D5291C-21.

According to the present invention, the rubber-derived pyrolysis oil may have a C/H atomic ratio of at least 0.60, such as at least 0.65, or at least 0.70, or at least 0.75. The rubber-derived pyrolysis oil may have a C/H atomic ratio of 1.0 or less, such as 0.95 or less, or 0.90 or less, or 0.85 or less, or 0.80 or less. A person skilled in the art will appreciate that any range between any of the explicitly disclosed lower and upper limit is herein disclosed. Accordingly, the rubber-derived pyrolysis oil may have a C/H atomic ratio in a range of from 0.60 to 1.0, preferably from 0.65 to 1.0, preferably from 0.70 to 0.90, more preferably from 0.70 to 0.85. The C/H atomic ratio is calculated from the total carbon and the total hydrogen, which are determined as described above according to ASTM D5291C-21.

The rubber-derived pyrolysis oil may have:
a total carbon in a range of from 80.0 to 90.0 mass %, preferably from 85.0 to 90.0 mass %, more preferably from 86.0 to 90.0 mass %, most preferably from 87.0 to 90.0 mass %;
a total hydrogen in a range of 8.0 to 15.0 mass %, preferably from 8.0 to 11.0 mass %, more preferably from 8.5 to 10.5 mass %, most preferably from 9.0 to 10.0 mass %; and
a C/H atomic ratio in a range of from 0.60 to 1, preferably from 0.65 to 1.0, more preferably from 0.70 to 0.90, most preferably from 0.70 to 0.85;
   wherein the mass % is based on the total mass of the rubber-derived pyrolysis oil excluding water and ash content. The total carbon and the total hydrogen are determined according to ASTM D5291C-21. The C/H atomic ratio is calculated from the total carbon and the total hydrogen. The water content may be determined according to ASTM D4928-12R18 and the ash content may be determined according to ASTM D2415-20 (at 550° C.).

According to the present invention, the rubber-derived pyrolysis oil may have a total nitrogen of at least 0.01 mass %, such as at least 0.02 mass %, wherein the mass % is based on the total mass of the rubber-derived pyrolysis oil excluding water and ash content. The water content may be determined according to ASTM D4928-12R18 and the ash content may be determined according to ASTM D2415-20 (at 550° C.). The rubber-derived pyrolysis oil may have a total nitrogen of up to 1.00 mass %, such as up to 0.90 mass %, or up to 0.80 mass %, or up to 0.70 mass %, or up to 0.65 mass %, wherein the mass % is based on the total mass of the rubber-derived pyrolysis oil excluding water and ash content. A person skilled in the art will appreciate that any range between any of the explicitly disclosed lower and upper limit is herein disclosed. Accordingly, the rubber-derived pyrolysis oil may have a total nitrogen in a range of from 0.01 to 1.00 mass %, such as from 0.01 to 0.80 mass %, or from 0.01 to 0.65 mass %, wherein the mass % is based on the total mass of the rubber-derived pyrolysis oil excluding water and ash content. The total nitrogen is determined according to ASTM D5291C-21.

According to the present invention, the rubber-derived pyrolysis oil may have a total sulfur of up to 1.35 mass %, such as up to 1.30 mass %, or up to 1.25 mass %, or up to 1.20 mass %, or up to 1.15 mass %, or up to 1.10 mass %, wherein the mass % is based on the total mass of the rubber-derived pyrolysis oil excluding water and ash content. The water content may be determined according to ASTM D4928-12R18 and the ash content may be determined according to ASTM D2415-20 (at 550° C.). The total sulfur is determined according to ASTM D5291C-21.

The rubber-derived pyrolysis oil may have:
a total nitrogen of up to 1.00 mass %, preferably up to 0.80 mass %, more preferably up to 0.65 mass %; and
a total sulfur of up to 1.35 mass %, preferably up to 1.25 mass %, more preferably up to 1.20 mass %;
   wherein the mass % is based on the total mass of the rubber-derived pyrolysis oil excluding water and ash content. The total nitrogen and the total sulfur are determined according to ASTM D5291C-21. The water content may be determined according to ASTM D4928-12R18 and the ash content may be determined according to ASTM D2415-20 (at 550° C.).

According to the present invention, the rubber-derived pyrolysis oil may have:
a total carbon in a range of from 80.0 to 90.0 mass %, preferably from 85.0 to 90.0 mass %, more preferably from 86.0 to 90.0 mass %, most preferably from 87.0 to 90.0 mass %;
a total hydrogen in a range of from 8.0 to 15.0, preferably from 8.0 to 11.0 mass %, more preferably from 8.5 to 10.5 mass %, most preferably from 9.0 to 10.0 mass %;
a C/H atomic ratio in a range of from 0.60 to 1.0, preferably from 0.65 to 1.0, more preferably from 0.70 to 0.90, most preferably from 0.70 to 0.85;
a total nitrogen of up to 1.00 mass %, preferably up to 0.80 mass %, more preferably up to 0.65 mass %; and
a total sulfur of up to 1.35 mass %, preferably up to 1.25 mass %, more preferably up to 1.20 mass %;
   wherein the mass % is based on the total mass of the rubber-derived pyrolysis oil excluding water and ash content. The total carbon, total hydrogen, total nitrogen and total sulfur are determined according to ASTM D5291C-21. The C/H atomic ratio is calculated from the total carbon and the total hydrogen. The water content may be determined according to ASTM D4928-12R18 and the ash content may be determined according to ASTM D2415-20 (at 550° C.).

According to the present invention, the rubber-derived pyrolysis oil may have an ash content of less than 0.04 mass %, such as less than 0.03 mass %, or less than 0.02 mass %, or less than 0.01 mass %, wherein the mass % is based on the total mass of the rubber-derived pyrolysis oil. The ash content is determined according to ASTM D2415-20 (at 550° C.).

The rubber-derived pyrolysis oil may have a sieve residue of 250 mg/kg or less, such as 230 mg/kg or less, based on the total weight of the rubber-derived pyrolysis oil. The sieve residue is determined according to ASTM D4870-18 (25 μm mesh size).

According to the present invention, the TPO may have a total carbon of at least 85.0 mass %, such as at least 85.5 mass %, or at least 86.0 mass %, or at least 86.5 mass %, or at least 87.0 mass %, or at least 87.5 mass %, wherein the mass % is based on the total mass of the TPO excluding water and ash content. The water content may be determined according to ASTM D4928-12R18 and the ash content may be determined according to ASTM D2415-20 (at 550° C.). The TPO may have a total carbon of 90.0 mass % or less, such as 89.5 mass % or less, or 89.0 mass % or less, wherein the mass % is based on the total mass of the TPO excluding water and ash content. A person skilled in the art will appreciate that any range between any of the explicitly disclosed lower and upper limit is herein disclosed. Accordingly, the TPO may have a total carbon in a range of from 85.0 to 90.0 mass %, preferably from 86.0 to 90.0 mass %, more preferably from 87.0 to 90.0 mass %, wherein the mass % is based on the total mass of the TPO excluding water and ash content. The total carbon is determined according to ASTM D5291C-21.

According to the present invention, the TPO may have a total hydrogen of at least 8.0 mass %, such as at least 8.5 mass %, or at least 9.0 mass %, or at least 9.5 mass %, wherein the mass % is based on the total mass of the TPO excluding water and ash content. The water content may be determined according to ASTM D4928-12R18 and the ash content may be determined according to ASTM D2415-20 (at 550° C.). The TPO may have a total hydrogen of 11.0 mass % or less, such as 10.5 mass % or less, or 10.0 mass % or less, wherein the mass % is based on the total mass of the TPO excluding water and ash content. A person skilled in the art will appreciate that any range between any of the explicitly disclosed lower and upper limit is herein disclosed. Accordingly, the TPO may have a total hydrogen in a range of from 8.0 to 11.0 mass %, preferably from 8.5 to 10.5 mass %, more preferably from 9.0 to 10.0 mass %, wherein the mass % is based on the total mass of the TPO excluding water and ash content. The total hydrogen is determined according to ASTM D5291C-21.

According to the present invention, the TPO may have a C/H atomic ratio of at least 0.65, such as at least 0.70, or at least 0.75. The TPO may have a C/H atomic ratio of 1.0 or less, such as 0.95 or less, or 0.90 or less, or 0.85 or less, or 0.80 or less. A person skilled in the art will appreciate that any range between any of the explicitly disclosed lower and upper limit is herein disclosed. Accordingly, the TPO may have a C/H atomic ratio in a range of from 0.65 to 1.0, preferably from 0.70 to 0.90, more preferably from 0.70 to 0.85. The C/H atomic ratio is calculated from the total carbon and the total hydrogen, which are determined as described above according to ASTM D5291C-21.

The TPO may have:
a total carbon in a range of from 85.0 to 90.0 mass %, preferably from 86.0 to 90.0 mass %, more preferably from 87.0 to 90.0 mass %;
a total hydrogen in a range of 8.0 to 11.0 mass %, preferably from 8.5 to 10.5 mass %, more preferably from 9.0 to 10.0 mass %; and
a C/H atomic ratio in a range of from 0.65 to 1.0, preferably from 0.70 to 0.90, more preferably from 0.70 to 0.85;
   wherein the mass % is based on the total mass of the TPO excluding water and ash content. The water content may be determined according to ASTM D4928-12R18 and the ash content may be determined according to ASTM D2415-20 (at 550° C.). The total carbon and the total hydrogen are determined according to ASTM D5291C-21. The C/H atomic ratio is calculated from the total carbon and the total hydrogen.

According to the present invention, the TPO may have a total nitrogen of at least 0.40 mass %, such as at least 0.45 mass %, or at least 0.50 mass %, wherein the mass % is based on the total mass of the TPO excluding water and ash content. The water content may be determined according to ASTM D4928-12R18 and the ash content may be determined according to ASTM D2415-20 (at 550° C.). The TPO may have a total nitrogen of 0.65 mass % or less, such as 0.60 mass % or less, or 0.55 mass % or less, wherein the mass % is based on the total mass of the TPO excluding water and ash content. A person skilled in the art will appreciate that any range between any of the explicitly disclosed lower and upper limit is herein disclosed. Accordingly, the TPO may have a total nitrogen in a range of from 0.40 to 0.65 mass %, preferably from 0.45 to 0.65 mass %, more preferably from 0.45 to 0.60 mass %, wherein the mass % is based on the total mass of the TPO excluding water and ash content. The total nitrogen is determined according to ASTM D5291C-21.

According to the present invention, the TPO may have a total sulfur of up to 1.35 mass %, such as up to 1.30 mass %, or up to 1.25 mass %, or up to 1.20 mass %, or up to 1.15 mass %, or up to 1.10 mass %, wherein the mass % is based on the total mass of the TPO excluding water and ash content. The water content may be determined according to ASTM D4928-12R18 and the ash content may be determined according to ASTM D2415-20 (at 550° C.). The total sulfur is determined according to ASTM D5291C-21.

The TPO may have:
a total nitrogen of from 0.40 to 0.65 mass %, preferably from 0.45 to 0.65 mass %, more preferably from 0.45 to 0.60 mass %; and
a total sulfur of up to 1.35 mass %, preferably up to 1.25 mass %, more preferably up to 1.20 mass %;
   wherein the mass % is based on the total mass of the TPO excluding water and ash content. The water content may be determined according to ASTM D4928-12R18 and the ash content may be determined according to ASTM D2415-20 (at 550° C.). The total nitrogen and the total sulfur are determined according to ASTM D5291C-21.

According to the present invention, the TPO may have:
a total carbon in a range of from 85.0 to 90.0 mass %, preferably from 86.0 to 90.0 mass %, more preferably from 87.0 to 90.0 mass %;
a total hydrogen in a range of 8.0 to 11.0 mass %, preferably from 8.5 to 10.5 mass %, more preferably from 9.0 to 10.0 mass %;
a C/H atomic ratio in a range of from 0.65 to 1.0, preferably from 0.70 to 0.90, more preferably from 0.70 to 0.85;
a total nitrogen of from 0.40 to 0.65 mass %, preferably from 0.45 to 0.65 mass %, more preferably from 0.45 to 0.60 mass %; and
a total sulfur of up to 1.35 mass %, preferably up to 1.25 mass %, more preferably from 0.90 to 1.20 mass %;
   wherein the mass % is based on the total mass of the TPO excluding water and ash content. The water content may be determined according to ASTM D4928-12R18 and the ash content may be determined according to ASTM D2415-20 (at 550° C.). The total carbon, total hydrogen, total nitrogen and total sulfur are determined according to ASTM D5291C-21. The C/H atomic ratio is calculated from the total carbon and the total hydrogen.

According to the present invention, the TPO may have an ash content of less than 0.04 mass %, such as less than 0.03 mass %, or less than 0.02 mass %, or less than 0.01 mass %, wherein the mass % is based on the total mass of the TPO. The ash content is determined according to ASTM D2415-20 (at 550° C.).

The TPO may have a sieve residue of 250 mg/kg or less, such as 230 mg/kg or less, based on the total weight of the TPO. The sieve residue is determined according to ASTM D4870-18 (25 μm mesh size).

According to the present invention, the carbon black feedstock may further comprise conventional carbon black feedstock, in particular a conventional carbon black feedstock used in the gas black process. Conventional carbon black feedstock may include coal tar distillates, residual oils produced during the catalytic cracking of petroleum fractions, residual oils produced during olefin production through cracking of naphta or gas oil, or mixture of combinations of any of the foregoing, preferably coal tar distillates.

The carbon black feedstock of the present invention may comprise up to 90 wt.-%, such as up to 85 wt.-%, or up to 80 wt.-%, or up to 75 wt.-%, or up to 70 wt.-%, or up to 65 wt.-%, or up to 60 wt.-%, or up to 55 wt.-%, or up to 50 wt.-%, or up to 45 wt.-%, or up to 40 wt.-%, or up to 35 wt.-%, or up to 30 wt.-%, or up to 25 wt.-%, or up to 20 wt.-%, or up to 15 wt.-%, or up to 10 wt.-%, or up to 5 wt.-% of the conventional carbon black feedstock, based on the total weight of the carbon black feedstock. Accordingly, the carbon black feedstock of the present invention may comprise up to 70 wt.-%, preferably up to 50 wt.-%, more preferably of 30 wt.-%, most preferably up to 10 wt.-% of the conventional carbon black feedstock, based on the total weight of the carbon black feedstock.

According to the present invention, the carbon black feedstock may comprise at least 5 wt.-%, such as least 10 wt.-%, or at least 15 wt.-%, or at least 20 wt.-%, or at least 25 wt.-%, or at least 30 wt.-%, or at least 35 wt.-%, or at least 40 wt.-%, or at least 45 wt.-%, or at least 50 wt.-%, or at least 55 wt.-%, or at least 60 wt.-%, or at least 65 wt.-%, or at least 70 wt.-%, or at least 75 wt.-%, or at least 80 wt.-%, or at least 85 wt.-%, or at least 90 wt.-%, or at least 95 wt.-%, or at least 99 wt.-% of the rubber-derived pyrolysis oil, based on the total weight of the carbon black feedstock. Accordingly, the carbon black feedstock of the present invention may comprise at least 10 wt.-%, preferably at least 30 wt.-%, more preferably at least 50 wt.-%, even more preferably at least 70 wt.-%, most preferably at least 90 wt.-% of the rubber-derived pyrolysis oil, based on the total weight of the carbon black feedstock. The carbon black feedstock of the present invention may consist of the rubber-derived pyrolysis oil.

The present invention further relates to a carbon black obtained by the process of the present invention as described above. The carbon black of the present invention obtained by the process of the present invention may have an oil absorption number (OAN) of equal to or more than 100 mL/100 g, such as equal to or more than 105 mL/100 g, or equal to or more than 110 mL/100 g, or equal to or more than 115 mL/100 g. Preferably, the carbon black of the present invention may have an oil absorption number (OAN) of equal to or more than 110 mL/100 g, more preferably equal to or more than 115 mL/100 g. The carbon black of the present invention may have an oil absorption number (OAN) of equal to or less than 180 mL/100 g, such as equal to or less than 175 mL/100 g, or equal to or less than 170 mL/100 g, or equal to or less than 165 mL/100 g, or equal to or less than 160 mL/100 g. The carbon black according to the present invention can have an OAN in a range between any of the recited lower and upper limit values. Accordingly, carbon black of the present invention may have an oil absorption number (OAN) in a range of from 110 mL/100 g to 180 mL/100 g, preferably from 110 mL/100 g to 170 mL/100 g, more preferably from 110 mL/100 g to 165 mL/100 g, even more preferably from 115 mL/100 g to 165 mL/100 g. The OAN is determined according to ASTM D2414-21.

The carbon black of the present invention may have a volatile matter content of equal to or more than 6%, such as equal to or more than 7%. The carbon black of the present invention may have a volatile matter content of equal to or less than 12%, such as equal to or less than 11%, or less than or equal to 10%. The carbon black according to the present invention can have a volatile matter content in a range between any of the recited lower and upper limit values. Accordingly, the carbon black of the present invention may have a volatile matter content in a range of from 6 to 12%, preferably from 6 to 10%, more preferably from 7 to 10%. The volatile matter content (at 950° C.) is determined according to DIN 53552:1977-09. The volatile contents are directed to carbon blacks of the present invention, which have not been oxidized or functionalized after the production. The process of the present invention may provide for carbon blacks having higher volatile content than gas black processes using conventional carbon black feedstocks. High contents of volatiles, i.e., high concentrations of surface oxides, may decrease the vulcanization rate and improve the flow characteristics of inks. Moreover, the gloss and blackness of lacquers and coatings comprising the carbon blacks having higher volatile content may be increased. To amend their color properties, carbon blacks may be after-treated by oxidation. The process of the present invention may avoid such after-treatments.

The carbon black of the present invention may have a STSA of equal to or more than 70 m²/g, such as equal to or more than 80 m²/g, or equal to or more than 90 m²/g. The carbon black may have a STSA of equal to or less than 300 m²/g, such as equal to or less than 290 m²/g, or equal to or less than 270 m²/g, or equal to or less than 250 m²/g. The carbon black according to the present invention can have a STSA in a range between any of the recited lower and upper limit values. Accordingly, the carbon black may have a STSA in a range of from 70 to 300 m²/g, preferably from 70 to 270 m²/g, more preferably 80 to 250 m²/g. The STSA is determined according to ASTM D6556-19a.

The carbon black of the present invention may have a BET of equal to or more than 80 m²/g, such as equal to or more than 90 m²/g, or equal to or more than 95 m²/g. The carbon black may have a BET of equal to or less than 350 m²/g, such as equal to or less than 320 m²/g, or equal to or less than 300 m²/g. The carbon black according to the present invention can have a BET in a range between any of the recited lower and upper limit values. Accordingly, the carbon black may have a BET in a range of from 80 to 350 m²/g, preferably from 80 to 320 m²/g, more preferably 90 to 300 m²/g. The STSA is determined according to ASTM D6556-19a.

The carbon black of the present invention may have a tint strength of equal to or more than 30%, such as equal to or more than 40%, or equal to or more than 50%. The carbon black of the present invention may have a tint strength of equal to or less than 250%, such as equal to or less than 230%, or equal to or less than 200%, or equal to or less than 160%. The carbon black according to the present invention can have a tint strength in a range between any of the recited lower and upper limit values. Accordingly, the carbon black may have tint strength in a range of from 30 to 250%, preferably 40 to 200%, more preferably 50 to 160%. The tint strength is determined according to ASTM D3265-21.

The carbon black of the present invention can have a pMC (percent of modern carbon) of 1% or more, such as 2% or more, or 3% or more, or 4% or more, or 5% or more, or 6% or more, or 7% or more, or 8% or more, or 9% or more, or 10% or more, or 12% or more, or 13% or more, or 14% or more, or 15% or more. The carbon black of the present invention can have a pMC (percent of modern carbon) of 95% or less, such as 90% or less, or 80% or less, or 70% or less, or 60% or less, or 55% or less, or 50% or less, or 45% or less. The carbon black according to the present invention can have a pMC in a range between any of the recited lower and upper limit values. Accordingly, the carbon black may have a pMC in a range of from 1 to 65%, preferably 5 to 60%, more preferably 10 to 60%, most preferably 15 to 55%. The pMC is determined according to ASTM D6866-20 Methode B (AMS). For each sample, a ratio of 14C/13C is calculated and compared to measurements made on Oxalic Acid II standard (NIST-4990C). The measured values (pMC) are corrected by d13C measured using an isotope ratio mass spectrometer (IRMS).

According to the present invention, the carbon black can be oxidized. Herein, the term “oxidized” means that the carbon black has been subjected to an oxidative treatment and thus comprises oxygen-containing functional groups. Oxidized carbon blacks, unlike non-oxidized carbon blacks, thus generally have a notable oxygen content and have oxygen-containing functional groups, which can be exemplified, but are not limited to, quinone, carboxyl, phenol, lactol, lactone, anhydride and ketone groups. For example, oxidized carbon blacks can have an oxygen content of 0.5 wt.-% or more, such as 1 wt.-% or more, or 2 wt.-% or more, based on the total weight of the oxidized carbon black material. Typically, the oxygen content does not exceed 20 wt.-%, based on the total weight of the oxidized carbon black material. For example, the oxidized carbon black can contain from 0.5 wt.-% to 20 wt.-%, or from 1 wt.-% to 15 wt.-%, or from 2 wt.-% to 10 wt.-%, or from 2 wt.-% to 5 wt.-% of oxygen, based on the total weight of the oxidized carbon black material.

Oxidized carbon blacks can be produced by various methods known in the art such as for example disclosed in U.S. Pat. Nos. 6,120,594 and 6,471,933. Suitable methods include oxidation of a carbon black material with an oxidizing agent as for example peroxides such as hydrogen peroxide, persulfates such as sodium and potassium persulfates, hypohalites such as sodium hypochlorite, ozone or oxygen gas, transition metal-containing oxidants such as permanganate salts, osmium tetroxide, chromium oxides, ceric ammonium nitrates or oxidizing acids such as nitric acid or perchloric acid, and mixtures or combinations thereof.

According to the present invention, the carbon black can further be functionalized. Carbon blacks can be functionalized by treatment using functionalizing agents. Functionalized carbon blacks can for example be obtained by treating an oxidized carbon black with a sulfur-containing primary or secondary amine or a salt thereof as described in WO 2021/001156 A1. Accordingly, the treatment leads to a chemical change of the oxidized carbon black by the sulfur-containing amine imparting functionalities derived from the treatment agent such as sulfur-containing moieties and/or amine groups to the oxidized carbon black.

The present invention further relates to use of the carbon black of the present invention as reinforcing filler or additives, UV stabilizer, conductive carbon black or pigment, preferably pigment.

Furthermore, the present invention relates to use of the carbon black of the present invention in rubber and rubber mixtures, plastics, inks such as printing inks, inkjet inks or other inks, toners, lacquers, coatings, papers, adhesives, in batteries or black matrix applications, preferably inks such as printing inks, inkjet inks or other inks, toners, lacquers or coatings, preferably inks, lacquers or coatings.

The invention further relates to a composition comprising the carbon black of the present invention. The composition of the present invention may be an ink composition, a coating composition or a lacquer composition.

The composition of the present invention may further comprise a polymer component. The polymer component may comprise thermoplastic polymers, duroplastic or thermoset polymers as well as mixtures or combinations thereof. For example, polymer components that can be used in compositions of the present invention include epoxies, acrylics, urethanes, polyesters, polycarbonates, polysulfones, polyimides, polyethers, such as polyether sulfone, and polyolefins such as light, medium and high density polyethylene, ethylenepropylene copolymers, either with random or block configuration, polypropylenemaleic acid anhydride, polystyrene, styrene-acrylonitrile copolymers, acrylonitrile-butadiene-styrene copolymers, ethylene vinyl acetate, ethylene-acrylic acid copolymers, vinyl chloride-polypropylene copolymers, polyisobutylene, polybutadiene, and crosslinked polyethylene, whether chemically, thermally, UV or E-beam (EB) crosslinked, and polyphenylene sulfide, polyetheretherketone, polyetherimide, polyarylsulfone and polypropylene oxide modified polyether sulfones, or mixtures or combinations of any of the foregoing.

The composition according to the present invention may optionally further comprise water and/or one or more than one organic solvent. For example, water and/or the organic solvent can serve as a dissolving or dispersing medium for the polymer component and the carbon black of the present invention. The composition according to the present invention may for example be a liquid composition such as an aqueous or organic dispersion. An organic solvent can comprise alcohols, ketones, esters, aliphatic or aromatic hydrocarbons or mixtures thereof. The composition according to the present invention may be a powder composition.

The composition according to the present invention may comprise 0.1 to 30 wt.-%, preferably 0.5 to wt. %, more preferably 1 to 15 wt.-% of the carbon black of the present invention, based on the total weight of the composition.

The present invention further relates to use of the composition of the present invention for printing and coating applications.

Furthermore, the present invention relates to an article prepared from the composition of the present invention. The article of the present invention may a coating or a colored or printed article.

### Examples

The invention will now be further illustrated by the following Examples. All parts and percentages mentioned herein are based on weight, unless indicated otherwise.

### Carbon Black Production

A carbon black is produced in a gas black process as described above using a conventional gas black reactor as displayed in H. Ferch “Pigmentruße”, 1^{st} edition, Curt R. Vincentz Verlag, Hannover (1995) on page 33. A procedure similar to that described in Example 1 of U.S. Pat. No. 3,978,019 A was used, except that a rubber-derived pyrolysis oil was used instead of the Russoel. ThermoTireOil RR (commercially available from Pyrum Innovations AG (Germany)) was used as the rubber-derived pyrolysis oil. The Thermo TireOil RR was subjected to a fractional distillation. The fractions of the distilled ThermoTireOil RR with a flash point of at least 65° C. were used. The flash point was determined according to ASTM D93 B.

The properties of the carbon black prepared by the gas black process using a rubber-derived pyrolysis oil as the carbon black feedstock were determined and are listed in Table 1.

TABLE 1

| Property | Standard | Ex. 1 |
|---|---|---|
| OAN [mL/100 g] | ASTM D2414-21 | 132.7 |
| Volatile matter content [%] | DIN 53552:1977-09 | 7.1 |
| | (at 950° C.) | |
| STSA [m²/g] | ASTM D6556-19a | 102.7 |
| BET[m²/g] | ASTM D6556-19a | 116.2 |
| Tint strength [%] | ASTM D3265-21 | 128.6 |

The carbon black of Example 1 as well as the following commercially available gas blacks, which are obtained using conventional feedstock, were used to prepare aqueous and solvent-borne coating compositions.
Printex® U: Gas black with an OAN of 115 mL/100 g, a volatile matter content of 5%, and a BET of 92 m²/g, commercially available from Orion Engineered Carbons GmbH
Colour Black S160: Gas black with an OAN of 128 mL/100 g, a volatile matter content of 5%, and a BET of 180 m²/g, commercially available from Orion Engineered Carbons GmbH

### Preparation of Aqueous Coating Composition (“Reference Aqueous Coating System”)

### a) Preparation of Aqueous Dispersions of the Respective Carbon Blacks:

The aqueous dispersion of the respective carbon blacks is produced as follows in Table 2.

TABLE 2

| Aqueous dispersion | |
|---|---|
| TEGO ^{®} Dispers 760W¹ | 20.8 g |
| Deionized water | 48.4 g |
| TEGO ^{®} Foamex 830² | 0.3 g |
| Dimethylethanolamine (DMEA) | 0.1 g |
| Carbon Black | 10.4 g |
| Total | 80.0 g |
| Carbon black concentration (total) | 13% |

¹Non-ionic wetting and dispersing additive (commercially available from Evonik Operations GmbH(Germany))
²Organic polymer, silicone-free defoamer containing fumed silica (commercially available from Evonik Operations GmbH) (Germany))

A Skandex dispersing beaker (180 mL, diameter 5.3 cm, height 12.5 cm) was charged with TEGO® Dispers 760W and deionized water and stirred with a spatula. TEGO® Foamex 830 was added and the mixture was stirred with a spatula. The respective carbon black was added and the mixture was stirred with a spatula until the carbon black was completely wetted. Subsequently, dispersing using a Pendraulik LR 34 dissolver at 4000 rpm for 5 min using a dispersing disc having a diameter of 40 mm was carried out. The pH of the dispersion was measured. If the pH of the dispersion was below the required range of 8.5 to 9.2, the pH was adjusted by using DMEA. Dispersing using a Skandex disperser DAS 200 for 60 min using 540 g chromanite steel beads having a diameter of 3 mm was carried out while colling at level 2. Subsequently, the steel beads were filtered off and the pH of the dispersion was measured. If the pH of the dispersion was below the required range of 8.2 to 8.7, the pH was adjusted by using DMEA (50 wt.-% in water).

### b) Preparation of Reference Lacquer a:

The reference lacquer A was produced as follows in Table 3.

TABLE 3
Formulation of reference lacquer A

| ALBERDINGK ^{®} U 9800¹ | 75.8 g |
|---|---|
| Butyl glycol | 13.0 g |
| BYK ^{®}-024² | 0.6 g |
| TEGO ^{®} WET 280³ | 0.4 g |
| DMEA | 0.2 g |
| Deionized water | 10.0 g |
| Total | 100.0 g |
| Non-volatile content | 26.5% |

¹Solvent-free aliphatic polyester polyurethane dispersion (commercially available from Alberdingk Boley GmbH (Germany))
²Volatile organic (VOC)-free silicone-containing defoamer (commercially available from BYK-Chemie GmbH (Germany))
³Liquid polyether siloxane copolymer (commercially available from Evonik Operations GmbH (Germany))

The ALBERDINGK® U 9800 was added to a vessel and stirred by a Pendraulik LR 34 dissolver. The butyl glycol, BYK®-024, TEGO® WET 280, DMEA and deionized water were premixed and added to the ALBERDINGK® U 9800. The mixture was dispersed at 1000 rpm using a dispersing disc having a diameter of 40 mm. Subsequently, the mixture was homogenized for 5 min at 1500 rpm. After the preparation of the reference lacquer, the reference lacquer was left overnight.

The quality of the reference lacquer A was controlled by applying the reference lacquer A onto a glass plate (130×90×1 mm) and drawing down the reference lacquer A with a film drawing bar having a slot height of 200 μm, wet, with uniform tension and pressure. Care was taken to ensure that there were no air bubbles in the stripe of the reference lacquer A. The film drawing bar was placed over the stripe of the reference lacquer A and drawn uniformly across the plate. A drawdown was produced which is approximately 10 cm long and 6 cm wide.

After the drawdown procedure, the wet coating film on the glass plate was flashed off at room temperature (20° C.) for 15 min and then the coated glass plate was dried at 60° C. for 15 min.

The coating prepared from the reference lacquer A was checked for defects such as craters, spots, and irregularities. In case of a significant number of defects the reference lacquer was prepared anew for use in the formulation of the subsequently described coating composition.

### c) Preparation of Aqueous Coating Compositions

Aqueous coating compositions are prepared from the reference lacquer A and the aqueous dispersions from the respective carbon blacks (Table 2) according to the following formulation of Table 4.

TABLE 4
Formulation of the aqueous coating compositions

| Aqueous dispersion of carbon black | 2.3 g |
|---|---|
| Reference lacquer A | 17.7 g |
| Total | 20.0 g |
| Carbon black concentration (total) | 1.5% |

The aqueous dispersion prepared from the respective carbon blacks and the reference lacquer A are weight in the above-indicated amounts into an 80 m¹ beaker and homogenized vigorously with a spatula until homogeneous to yield the corresponding aqueous coating composition.

### Preparation of Solvent-Borne Coating Composition

a) Preparation of Solvent-Borne Dispersions from the Respective Carbon Blacks:

The solvent-borne dispersions of the respective carbon blacks were produced as follows in Table 5.

TABLE 5

| Aqueous dispersion | |
|---|---|
| Setal ^{®} F 310 SN¹ | 53.9 g |
| Shellsol ^{®} A² | 18.0 g |
| Carbon Black | 8.1 g |
| Total | 80.0 g |
| Carbon black concentration (total) | 10.1% |

¹Short-oil alkyd resin based on saturated fatty acids (commercially available from Allnex(Germany))
²Solvent (commercially available from Kremer Pigmente GmbH (Germany))

A Skandex dispersing beaker (180 mL, diameter 5.3 cm, height 12.5 cm) was charged with Setal® F 310 SN and Shellsol® A and homogenized vigorously with a spatula. The respective carbon black was added and the mixture was stirred with a spatula until the carbon black was completely wetted. Subsequently, dispersing using a Pendraulik LR 34 dissolver at 4000 rpm for 5 min using a dispersing disc having a diameter of 40 mm was carried out. Dispersing using a Skandex disperser DAS 200 for 60 min using 550 g of steel beads having a diameter of 2 mm was carried out while colling at level 2. Subsequently, the steel beads were filtered off.

### b) Preparation of Solvent-Borne Coating Compositions:

Solvent-borne coating compositions were prepared from the thus obtained solvent-borne dispersions according to the following formulation (see Table 6).

TABLE 6
Formulation of the solvent-borne coating compositions

| Solvent-borne dispersion of carbon black | 4.4 g |
|---|---|
| Setal ^{®} F 310 SN¹ | 7.3 g |
| Maprenal ^{®} MF 800/55 IB² | 4.8 g |
| EB-Thinner RL 395-03 | 3.5 g |
| Total | 20 g |
| Carbon black concentration (total) | 5.0% |

¹Short-oil alkyd resin based on saturated fatty acids (commercially available from Allnex(Germany))
²Isobutylated melamine formaldehyde resin (commercially available from Prefere Resins (Germany))
³Solvent mixture consisting of 545.5 g xylene, 109.1 g 1-ethoxy-2-propanol, 72.7 g butanol; 36.4 g Baysilone ^{®}-paint additive OL 17 (10% in xylene) commercially available from OM Group, Inc. (USA)), 36.4 g of butylglycol acetate

The components were weight in the indicated amounts into a 180 m¹ beaker and homogenized vigorously with a spatula for 10 min to yield the corresponding solvent-borne coating composition.

Preparation of Films from the Coating Compositions

Films were prepared as follows from the aqueous coating compositions as well as from the solvent-borne coating compositions.

The respective coating composition was applied onto a glass plate (130×90×1 mm) and drawn down with a film drawing bar having a slot height of 200 μm (in case of the aqueous coating compositions) or 100 μm (in case of the solvent-borne coating compositions), wet, with uniform tension and pressure. Care was taken to ensure that there were no air bubbles in the stripe of the coating composition. The film drawing bar was placed over the stripe of the coating composition and drawn uniformly across the plate. A drawdown was produced which is approximately 10 cm long and 6 cm wide.

After the drawdown procedure, the obtained wet coating film on the glass plate was flashed off at room temperature (20° C.) for 15 min and then the coated glass plate dried at 130° C. for 15 min (in case of the solvent-borne coating compositions) and flashed off at room temperature (20° C.) for 15 min and then dried at 60° C. for 15 min (in case of the aqueous coating compositions).

The thus prepared coating compositions were analyzed for their coloristic properties.

Coloristic characteristics of the thus obtained films prepared from the aqueous and solvent-borne coating compositions were measured using a Pausch Q-Color 35 spectrophotometer (45°/0° spectrophotometer) and the BCSWIN software. The measurement was made through the glass after calibration with a white calibration tile and a black hollow body. The spectrometer averaged over five individual measurements for each sample.

The hue-independent black value M_{Y} and hue-dependent black value Mc were calculated as follows from the tristimulus (XYZ) data derived from the measurement:

The hue-independent black value M_{Y} was calculated according to equation 1 from the tristimulus component Y of the measurement (illuminant) D65/10°:

$${M}_{Y} = 100 \cdot log ( \frac{100}{Y} ) \qquad ( 1 )$$

Subsequently, the hue-dependent black value was calculated according to equation 2:

$${M}_{c} = 100 \cdot log ( log ( \frac{{X}_{n}}{X} ) - log ( \frac{{Z}_{n}}{Z} ) + log ( \frac{{Y}_{n}}{Y} ) ) \qquad ( 2 )$$

wherein Xₙ/Zₙ/Yₙ (DIN6147) were tristimulus values of the coordinate origin, based on the illuminant and the observer (DIN5033/part 7/illuminant) D65/10° with
Xₙ=94.81 Zₙ=107.34 Yₙ=100.0.

The absolute hue contribution dM was calculated according to equation 3 from the black values Mc and M_{Y}:

$$d M = {M}_{c} - {M}_{Y} . \qquad ( 3 )$$

The Haze and the Gloss 20° were determined according to DIN EN ISO 2813:2015.

For determining the relative tinting strength, coating compositions comprising white pigments (TiO₂) and the aqueous or solvent-borne dispersions of the respective carbon blacks were prepared according to the following procedures.

### Preparation of Aqueous Coating Compositions

### a) Preparation of Reference Lacquer B:

The reference lacquer B was produced as follows in Table 7.

TABLE 7
Formulation of reference lacquer B

| TEGO ^{®} Dispers 760W¹ | 236.0 g |
|---|---|
| BYK ^{®}-024² | 8.0 g |
| Butyl glycol | 38.7 g |
| DMEA | 0.6 g |
| Kronos ^{®} 2064³ | 330.0 g |
| ALBERDINGK ^{®} U 9800⁴ | 291.8 g |
| Deionized water | 94.9 g |
| Total | 1000.0 g |
| TiO₂ concentration (total) | 33 % |

¹Non-ionic wetting and dispersing additive (commercially available from Evonik Operations GmbH (Germany))
²Volatile organic (VOC)-free silicone-containing defoamer (commercially available from BYK-Chemie GmbH (Germany))
³Titanium dioxide pigment (commercially available from Kronos Incorporated (USA))
⁴Solvent-free aliphatic polyester polyurethane dispersion (commercially available from Alberdingk Boley GmbH (Germany))

A dispersing beaker (850 mL) was charged with TEGO® Dispers 760W and BYK®-024 and homogenized vigorously with a spatula. 5 g of butyl glycol and DMEA were added and the mixture was homogenized vigorously with a spatula. Kronos® 2064 was added and the mixture was stirred with a spatula until the Kronos® 2064 was completely wetted. Subsequently, dispersing using a Pendraulik LR 34 dissolver at 4000 rpm for 5 min using a dispersing disc having a diameter of 60 mm was carried out. The dissolver was covered with aluminum foil to prevent evaporation of the solvent. The beaker was then checked with a spatula for adhering pigment agglomerates. The dispersion was cooled to a maximum of 30° C.

The ALBERDINGK® U 9800 was added to a vessel. 33.7 g of butyl glycol and deionized water were premixed and added to the ALBERDINGK® U 9800, while the mixture was dispersed at 1000 rpm using a dispersing disc having a diameter of 60 mm. Subsequently, the mixture was homogenized for 5 min at 1000 rpm. The thus prepared mixture was added to the mixture comprising TEGO® Dispers 760W, BYK®-024, butyl glycol, DMEA and Kronos® 2064, while the mixture was dispersed at 1000 rpm using a dispersing disc having a diameter of 60 mm. Subsequently, the mixture was homogenized for 5 min at 2000 rpm. The pH of the dispersion was measured. If the pH of the dispersion was below the required range of 8.5 to 9.0, the pH was adjusted by using DMEA. After the preparation of the reference lacquer B, the reference lacquer B was left overnight.

The quality of the reference white lacquer B was controlled by applying the reference lacquer B onto a glass plate (130×90×1 mm) and drawing down the reference lacquer B with a film drawing bar having a slot height of 200 μm, wet, with uniform tension and pressure. Care was taken to ensure that there were no air bubbles in the stripe of the reference lacquer B. The film drawing bar was placed over the stripe of the reference lacquer B and drawn uniformly across the plate. A drawdown was produced which is approximately 10 cm long and 6 cm wide.

After the drawdown procedure, the wet coating film on the glass plate was flashed off at room temperature (20° C.) for 15 min and then the coated glass plate was dried at 60° C. for 15 min.

The coating prepared from the reference lacquer B was checked for defects such as craters, spots, and irregularities. In case of a significant number of defects the reference lacquer was prepared anew for use in the formulation of the subsequently described coating composition.

### b) Preparation of Aqueous Coating Compositions

Aqueous coating compositions were prepared from the reference lacquer B and the aqueous dispersions of Table 2 according to the following formulation of Table 8.

TABLE 8
Formulation of the aqueous coating compositions

| | |
|---|---|
| Aqueous dispersion of carbon black | 1.4 g |
| Reference lacquer B | 18.6 g |
| Total | 20.0 g |

The aqueous dispersion prepared from the respective carbon blacks and the reference lacquer B were weight in the above-indicated amounts into a beaker and homogenized vigorously with an enamel paint brush. Subsequently, the mixture was homogenized for 2 min at 2000 rpm using a Speedmixer.

### Preparation of Solvent-Borne Coating Compositions

### a) Preparation of Reference Lacquer C:

The reference lacquer C was produced as follows in Table 9:

TABLE 9
Formulation of reference lacquer C

| | | |
|---|---|---|
| Setal ^{®} F 310 SN¹ | 67.35 | g |
| Kronos ^{®} 2310² | 45.0 | g |
| Maprenal ^{®} MF 800/55 IB³ | 31.5 | g |
| Xylene | 6.15 | g |
| Total | 150.0 | g |

| | |
|---|---|
| TiO₂ concentration (total) | 30% |

¹Short-oil alkyd resin based on saturated fatty acids (commercially available from Allnex(Germany))
2Titanium dioxide pigment (commercially available from Kronos Incorporated (USA))
³Isobutylated melamine formaldehyde resin (commercially available from Prefere Resins (Germany))

A dispersing beaker (180 mL) was charged with 60.0 g of Setal® F 310 SN. Kronos® 2301 was added and the mixture was homogenized vigorously with a spatula, until the Kronos 2310 was completely wetted. Subsequently, dispersing using a Pendraulik LR 34 dissolver at 4000 rpm for 5 min using a dispersing disc having a diameter of 40 mm was carried out. The beaker was checked with a spatula for adhering pigment agglomerates. Further dispersing using a Pendraulik LR 34 dissolver at 4000 rpm for 10 min using a dispersing disc having a diameter of 40 mm was carried out. The dissolver was covered with aluminum foil to prevent evaporation of the solvent. The dispersion was cooled to a maximum of 30° C. 7.35 g of Setal® F 310 SN, Maprenal® MF 800/55 IB, and xylene were added to the mixture and homogenized vigorously with a spatula after the respective addition. Subsequently, dispersing using a Pendraulik LR 34 dissolver at 1500 rpm for 5 min using a dispersing disc having a diameter of 40 mm was carried out.

### b) Preparation of Solvent-Borne Coating Compositions

Solvent-borne coating compositions are prepared from the reference lacquer C and the solvent-borne dispersions of Table 5 according to the following formulation of Table 10.

TABLE 10
Formulation of the aqueous coating compositions

| | |
|---|---|
| Solvent-borne dispersion of carbon black | 2.1 g |
| Reference lacquer B | 17.9 g |
| Total | 20.0 g |

The aqueous dispersion prepared from the respective carbon blacks and the reference lacquer B were weight in the above-indicated amounts into a beaker and homogenized vigorously with a spatula and subsequently with a rubber wiper.

Preparation of Films from the Coating Compositions

Films are prepared as follows from the aqueous coating compositions as well as from the solvent-borne coating compositions.

The respective coating composition was applied onto a glass plate (130×90×1 mm) and drawn down with a film drawing bar having a slot height of 150 μm, wet, with uniform tension and pressure. Care was taken to ensure that there are no air bubbles in the stripe of the coating composition. The film drawing bar was placed over the stripe of the coating composition and drawn uniformly across the plate. A drawdown was produced which is approximately 10 cm long and 6 cm wide.

After the drawdown procedure, the obtained wet coating film on the glass plate was flashed off at room temperature (20° C.) for 15 min and then the coated glass plate dried at 130° C. for 15 min (in case of the solvent-borne coating compositions) and flashed off at room temperature (20° C.) for 15 min and then dried at 60° C. for 15 min (in case of the aqueous coating compositions).

The thus prepared coating compositions were analyzed for the relative tinting strength. The relative tinting strength was determined according to DIN EN ISO 787-24:1995-10.

The results for coloristic properties of the aqueous coating compositions comprising the carbon blacks are summarized in Table 11 and for the solvent-borne coating compositions are summarized in Table 12.

TABLE 11
Aqueous coating composition

| Example | 2 | 3 | 4 |
|---|---|---|---|
| Carbon black | Ex. 1 | Printex ^{®} U | Colour Black S160 |
| Blackness MY [—] | 243 | 233 | 255 |
| dM [—] | 1.6 | −1.1 | 4.6 |
| Haze [Haze units HU] | 13 | 18 | 12 |
| Gloss 20° | 80 | 79 | 82 |
| [Gloss units GU] | | | |
| Relative tinting | 111.4 | 100 | 120.2 |
| strength [%] | | | |

TABLE 12
Solvent-borne coating compositions

| Example | 5 | 6 | 7 |
|---|---|---|---|
| Carbon black | Ex. 1 | Printex ^{®} U | Colour Black S160 |
| Blackness MY [—] | 264 | 256 | 271 |
| dM [—] | −1.8 | −1.8 | −2.7 |
| Haze [Haze units HU] | 14 | 17 | 16 |
| Gloss 20° | 87 | 87 | 88 |
| [Gloss units GU] | | | |
| Relative tinting | 122.2 | 100 | 115.7 |
| strength [%] | | | |

1. A process for producing carbon black through thermal oxidative decomposition of a carbon black feedstock, wherein the carbon black feedstock comprises rubber-derived pyrolysis oil, and wherein the production of the carbon black is carried out in a gas black reactor.

2. The process according to claim 1, wherein the rubber-derived pyrolysis oil comprises tire-derived pyrolysis oil (TPO).

3. The process according to claim 1, wherein the rubber-derived pyrolysis oil consists of tire-derived pyrolysis oil (TPO).

4. The process according to claim 1, wherein the rubber-derived pyrolysis oil has:
a total carbon in a range of from 80.0 to 90.0 mass %;
a total hydrogen in a range of 8.0 to 15.0 mass %; and
a C/H atomic ratio in a range of from 0.60 to 1.0;
wherein the mass % is based on the total mass of the rubber-derived pyrolysis oil excluding water and ash content and wherein the total carbon and the total hydrogen is determined according to ASTM D5291C-21; and/or
wherein the rubber-derived pyrolysis oil has:
a total nitrogen of up to 1.00 mass %; and
a total sulfur of up to 1.35 mass %,
wherein the mass % is based on the total mass of the rubber-derived pyrolysis oil excluding water and ash content and wherein the total nitrogen and the total sulfur is determined according to ASTM D5291C-21

5. The process according claim 2, wherein the tire-derived pyrolysis oil (TPO) has:
a total carbon in a range of from 85.0 to 90.0 mass %;
a total hydrogen in a range of 8.0 to 11.0 mass %; and
a C/H ratio in a range of from 0.65 to 1.0;
wherein the mass % is based on the total mass of the TPO excluding water and ash content and wherein the total carbon and the total hydrogen is determined according to ASTM D5291C-21.

6. The process according to claim 2, wherein the carbon black feedstock further comprises conventional carbon black feedstock comprising coal tar distillates, residual oils produced during the catalytic cracking of petroleum fractions, residual oils produced during olefin production through cracking of naphta or gas oil, or mixture of combinations of any of the foregoing, preferably coal tar distillates.

7. The process according to claim 2, wherein the carbon black feedstock comprises at least 10 wt.-%, preferably at least 30 wt.-%, more preferably at least 50 wt.-%, even more preferably at least 70 wt.-%, most preferably at least 90 wt.-% of the rubber-derived pyrolysis oil, based on the total weight of the carbon black feedstock, or
wherein the carbon black feedstock consists of the rubber-derived pyrolysis oil.

8. The process according to claim 2, comprising
vaporizing the carbon black feedstock in a carrier gas stream, burning the carrier gas stream loaded with the carbon black feedstock in the presence of air in burners to form the carbon black,
and terminating the carbon black formation.

9. A carbon black obtained by the process according to claim 2, wherein the carbon black is a gas black.

10. The carbon black according to claim 9, wherein the carbon black has:
an oil absorption number (OAN) of equal to or more than 110 mL/100 g;
and/or
a volatile matter content of equal to or more than 6%;
wherein the OAN is determined according to ASTM D2414-21, and the volatile matter content (at 950° C.) is determined according to DIN 53552:1977-09.

11. The carbon black according to claim 9, wherein the carbon black has at least one, more than one or all of:
an OAN in a range of from 110 to 180 mL/100 g, preferably 115 to 165 mL/100 g; wherein the OAN is determined according to ASTM D2414-21;
a volatile matter content in a range of from 6% to 25%; wherein the volatile matter content (at 950° C.) is determined according to DIN 53552:1977-09,
a STSA in a range of from 70 to 300 m²/g, preferably from 70 to 270 m²/g, more preferably 80 to 250 m²/g; wherein the STSA is determined according to ASTM D6556-19a;
a BET surface area in a range of from 80 to 350 m²/g, preferably from 80 to 320 m²/g, further preferably from 90 to 300 m²/g; wherein the BET surface area is determined according to ASTM D6556-19a,
a tint strength in a range of from 30 to 250%, preferably from 50 to 160%; wherein the sulfur content is determined according to ASTM D3265-21, and
a pMC (percent of modern carbon) in a range of from 1 to 65%, preferably from 5 to 60%, more preferably from 10 to 60%, even more preferably from 15 to 55%, wherein the pMC is determined according to ASTM D6866-20 Methode B (AMS).

12. Use of the carbon black according to claim 9, as reinforcing filler or additives, UV stabilizer, conductive carbon black or pigment, preferably pigment.

13. Use of the carbon black according to claim 9, in rubber and rubber mixtures, plastics, inks such as printing inks, inkjet inks or other inks, toners, lacquers, coatings, papers, adhesives, in batteries or black matrix applications, preferably inks, lacquers or coatings.

14. A composition comprising the carbon black according to claim 9, wherein the composition preferably is an ink composition, a coating composition or a lacquer composition.

15. An article prepared from the composition according to claim 14.
